(19) United States
(12) Patent Application Publication
(10) Pub. No.: US 2004/0260949 A1
(43) Pub. Date: Dec. 23, 2004

(54) Chaining of services

(76) Inventors: Norihiro Edwin Aoki, Sunnyvale, CA (US); Conor Cahill, Waterford, VA (US)

Correspondence Address: GLENN PATENT GROUP, 3475 EDISON WAY, SUITE L, MENLO PARK, CA, 94025, US

(21) Appl. No.: 10/801,406

(22) Filed: Mar. 15, 2004

Related U.S. Application Data
(63) Continuation-in-part of application No. 10/600,121, filed on Jun. 20, 2003.

(51) Int. Cl. H04L 9/00

(52) U.S. Cl. 713/201

(57) ABSTRACT

A method and apparatus is provided for invoking authenticated transactions on behalf of a user when the user is not present. For example, the invention allows a subscription to take actions that would otherwise require authentication. A method and apparatus is provided that gives apparent authority to a service that allows the service to get services from other services without revisiting the client. Thus, the architecture enables a Web Services Provider to assume the role of a Web Services Client and invoke other services required to perform its service. As each Web Services Provider calls another Web Services Provider, the Discovery Service adds the Web Services Provider's footprint to the Service Assertions it passes on such that a trail of Web Services Providers is imprinted into the Service Assertion and is visible to the Discovery Service. Each Web Services Provider in the chain can also add permission requests.

This application is a Continuation in Part to U.S. Ser. No. 10/600,121 filed Jun. 20, 2003 (Attorney Docket No. AOL0072).

### BACKGROUND OF THE INVENTION

1. Technical Field

The invention relates generally to the field of network based services and structures.

More particularly, the invention relates to allowing a Web service to request a chain of one or more other Web services on behalf of a client.

2. Description of the Prior Art

In a typical e-commerce computing environment or specifically in any computer system with which a client performs transactions, identification and authentication mechanisms are essential for identifying and authenticating the client requesting usage of system resources. A common implementation of an authentication mechanism uses a user identification (ID) along with a password. Thus, in this way, a client is accountable for the use of such system resources.

Consider an example of a user surfing the World Wide Web (Web) and desiring to purchase an item from a particular vendor's Web site. Referring to FIG. 1, a schematic diagram of main components according to the prior art, the client, referred to herein as a Principal 102, logs onto the Principal's service provider 104 for accessing the Web. In this example, after searching many sites, the Principal 102 chooses to purchase an item from a Vendor's Web site 106. The service provider 104 and the Vendor's Web site 106 are shown connected as they appear that way from the point of view of the Principal 102. In this example, the Principal 102 acts as a principal entity going to the Principal's wallet 108 to retrieve information needed by the Vendor's site 106 in order to complete the transaction. It could be that the user represented by the Principal 102 physically opens up the user's real-life wallet, pulls out a credit card, and enters the credit card number, expiration date, and other relevant data into the Vendor's Web site 106 application. The Principal 102 also could be copying and pasting from an online account. The Principal 102 could be providing account information to the Vendor's Web site 106 by a variety of means. It should be appreciated that in this example neither the service provider 104 nor the Vendor's Web site 106 has a session open with the Principal's wallet 108.

FIG. 2 illustrates another example of the Principal 102 completing a transaction with a Vendor's Web site 202. In this example, the Principal 102 buys an item from the Vendor's Web site 202, which stores previously entered relevant transaction data in an internal wallet account 204 of the Principal 102. It should be appreciated that in this example the vendor's Web site 202 is limited to obtaining payment information only from data stored on its own system. That is, the vendor's Web site 202 cannot obtain payment information of the Principal 102 from another Web site.

Referring to FIG. 3, suppose the service provider 104 is part of a portal or federation relationship 306 which also includes a Vendor Web site 302 and a Principal's wallet application 304, possibly on another Vendor's Web site. In this example, the Principal 102 identifies itself to the Wallet application 304 by using credentials passed on by the service provider 104, so that the Wallet 304 knows that the Principal 102 is authorized.

Several structures and methods have been described for network based services and structures, such as:

Martin Abadi, Michael Burrows, and Edward P. Wobber, Access Control Subsystem and Method for Distributed Computer System using Compound Principals, U.S. Pat. No. 5,173,939 (Dec. 22, 1992) disclose a distributed computer system having a number of computers coupled thereto at distinct nodes and a naming service with a membership table that defines a list of assumptions concerning which principals in the system are stronger than other principals, and which roles adopted by principals are stronger than other roles. Each object in the system has an access control list (ACL) having a list of entries. Each entry is either a simple principal or a compound principal. The set of allowed compound principals is limited to a predefined set of allowed combinations of simple principals, roles, delegations, and conjunctions in accordance with a defined hierarchical ordering of the conjunction, delegation, and role portions of each compound principal. The assumptions in the membership table reduce the number of entries needed in an ACL by allowing an entry to state only the weakest principals and roles that are to be allowed access. The reference checking process, handled by a reference monitor found at each node of the distributed system, grants an access request if the requestor is stronger than any one of the entries in the access control list for the resource requested. Furthermore, one entry is stronger than another entry if for each of the conjuncts in the latter entry there is a stronger conjunct in the former. Additional rules used by the reference monitor during the reference checking process govern the processes of comparing conjuncts in a requestor principal with the conjuncts in an access control list entry and of using assumptions to compare the relative strengths of principals and roles;

Anthony John Wasilewski, Douglas F. Woodhead, and Gary Lee Logston, Method and Apparatus for Providing Conditional Access in Connection-Oriented, Interactive Networks with a Multiplicity of Service Providers, U.S. Pat. No. 5,870,474 (Feb. 9, 1999) and U.S. Pat. No. 6,424,714 (Jul. 23, 2002) disclose a control system that provides secure transmission of programs, including at least one of video, audio, and data, between a service provider and a customer's set top unit over a digital network. Program bearing data packets are received in a first network protocol over a first data link and removed from the first network protocol. Packets representing a particular program requested by a customer having a set top unit are selected. Conditional access is provided to the selected program. In particular, program bearing packets are encrypted according to a first encryption algorithm using a first key, which is then encrypted according to a second encryption algorithm using a second key. The first keys are transported in packets to the customer's set top units along with the program packets. A public key cryptographic technique encrypts the second key such that the public key used in the encryption corresponds to the private key of the customer's set top unit. After the conditional access layers have been added, the packets are encapsulated and output in a second network protocol destined for the set top unit; and

Claire Griffin and Douglas Barnes, Trusted Delegation System, U.S. Pat. No. 5,958,050 (Sep. 28, 1999) disclose a trust manager that examines each new class before it is allowed to execute by examining a policy file which includes data structures defining security policies of the user system, a certificate repository for storing a plurality of certificates, a certificate being a data record which is digitally signed and which certifies claims relevant to a security evaluation, a code examiner adapted to analyze the portion of code to determine potential resource use of the portion of code and a trust evaluator adapted to evaluate certificate requirements of the portion of code based on policy rules extracted from the policy file and the potential resource use specified by the code examiner. The trust evaluator also determines, from certificates from the certificate repository and a code identifier identifying the portion of code, whether execution of the portion of code is allowed by the policy rules given the potential resource use, the code supplier and applicable certificates. Certificates and policies can be specified in hierarchical form, so that some levels of security can be delegated to trusted entities.

Suppose in FIG. 3 that the Principal's Wallet 304 requires information from a Principal's Address book on another Web site. Suppose further that such other Web site is part of the federation relationship or portal 306. It would be advantageous for the Principal's Wallet to be able to request the Principal's address information directly from the Principal's Address book directly on behalf of the client.

It would further be advantageous to provide a method and apparatus that supports an architecture which gives apparent authority from a client to a first service on a portal system and allows such first service to request other services from other entities of the portal system on behalf of the client.

It would further be advantageous to provide a method and apparatus to track each called Web service's footprint thereby providing a trail of called Web services that can be available in future actions.

### SUMMARY OF THE INVENTION

A method and apparatus is disclosed that supports an architecture which gives apparent authority from a client to a first Web service on a portal system that allows the Web service to request other services on the portal system without the first Web service having to revisit the client, i.e. a chain of services on behalf of the client. As each Web service calls another Web service, a Discovery Service entity adds the called Web service's footprint to a Service Assertion that the calling Web service passes on. Hence, a trail of Web services is imprinted into the Service Assertion and is visible to the Discovery Service. Each Web service in the chain can also add permission requests.

Also disclosed is a method and apparatus for invoking authenticated transactions on behalf of a user when the user is not present. For example, the invention allows a subscription to take actions that would otherwise require authentication, such as performing collections from a wallet, when the user is not present. Thus, the invention provides a form of delegation of authority.

### BRIEF DESCRIPTION OF THE DRAWINGS

FIG. 1 is a high level schematic diagram of a Web service system in which a Principal accesses a Vendor's Web site and a Principal's wallet according to a prior art system;

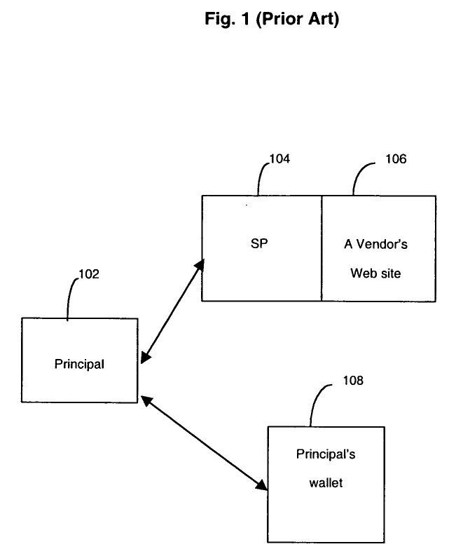

FIG. 2 is a high level schematic diagram of a Web service system in which a Principal accesses a Vendor's Web site that stores previously entered transactional data in an internal wallet subsystem according to another prior art system;

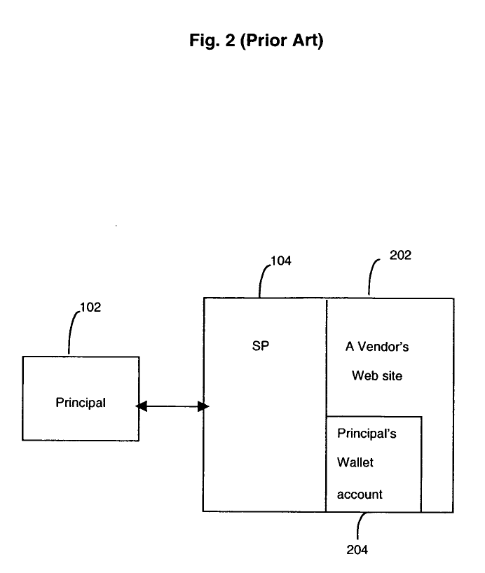

FIG. 3 is a high level schematic diagram of a Web service system in which a Principal accesses a Vendor's Web site and a Principal's wallet according to another prior art system;

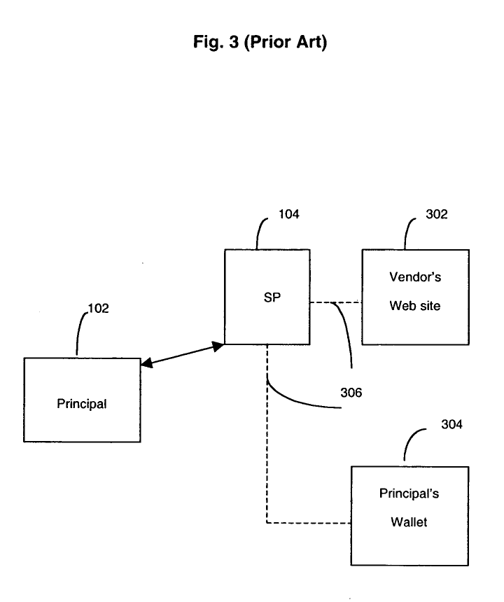

FIG. 4 is a high level schematic diagram of a Web service system in which a first Web service requests a transaction of a second Web service in the absence of the user according to the invention;

FIG. 5 is a high level functional block diagram of a Web service system in which one Web service requests another Web service on behalf of a client according to the invention; and

FIG. 6 is a flow diagram for invoking a first service hosted on a first server WSP 1, which in turn invokes a second service hosted at a second server WSP 2 shown in FIG. 5 according to the invention.

### DETAILED DESCRIPTION OF THE INVENTION

A method and apparatus is disclosed that supports an architecture which gives apparent authority from a client to a first Web service on a portal system that allows the Web service to request other services on the portal system without the first Web service having to revisit the client, i.e. a chain of services on behalf of the client. As each Web service calls another Web service, a Discovery Service entity adds the called Web service's footprint to a Service Assertion that the calling Web service passes on. Hence, a trail of Web services is imprinted into the Service Assertion and is visible to the Discovery Service. Each Web service in the chain can also add permission requests. A comprehensive description is provided in the section hereinbelow, An Exemplary Chaining of Services.

Also disclosed is a method and apparatus for invoking authenticated transactions on behalf of a user when the user is not present. For example, the invention allows a subscription to take actions that would otherwise require authentication, such as performing collections from a wallet, when the user is not present. Thus, the invention provides a form of delegation of authority. A comprehensive description is provided in the following section, User Not Present.

### User not Present

A method and apparatus is provided for invoking authenticated transactions on behalf of a user when the user is not present. For example, the invention allows a subscription to take actions that would otherwise require authentication, such as performing collections from a wallet, when the user is not present. Thus, the invention provides a form of delegation of authority.

In one embodiment of the invention, at a time when the user is present, a service provider essentially asks the user if the service provider can perform a certain transaction at a later point in time when the user is not present. If the user says, “Yes,” then the service provider sends a notification to register with either of, or with both of a trusted discovery service (DS) and the Web Service Provider (WSP) which performs the requested transaction. At this point and while the user is still present, the user can be asked to provide informational content related to the transaction. Thus, the permission to perform a requested transaction for when the user is not present is registered with any of the following: the DS alone, the WSP alone, or both the DS and the WSP. In essence, the registration indicates to the DS and to the WSP that the user gave the service provider permission to initiate the transaction in—the user's absence and on the user's behalf.

For invocation, when the service provider makes a request to enact the transaction at hand, it first contacts the DS. Technically speaking, the service provider makes a request via client software representing the user, referred to herein as the Web Service Client (WSC). The DS knows where to locate the WSP performing the transaction. At this point, which can be viewed as an invoke control point, the DS can check if the user gave permission for contacting the WSP when the user is not present. If permission was granted and control goes to the WSP, then, as the WSP is accessed to perform the given transaction, the WSP can do two things. The WSP can trust the DS and accept that if the DS said the user gave permission, then the WSP performs the transaction. Or, the WSP can decide to do the checking for permission itself, regardless if the DS did a prior check or not, and subsequently perform the transaction if the WSP discovers itself that permission was granted.

It should be appreciated that in another embodiment, only the DS is sent a notification of registration. In another embodiment, only the WSP is sent a notification of registration.

In one embodiment of the invention, the discovery service returns to the service provider (or WSC) a ticket, which the service provider uses when the user isn't present to interact with the WSP. The ticket serves as proof that the user gave permission to the service provider to act on the user's behalf when the user is not present.

In another embodiment of the invention, information representing the fact that the user gave permission to the service provider to act on the user's behalf is recorded in any of the DS, the WSP, and the service provider, such as in a table format.

It should be appreciated that in one embodiment of the invention, a user is provided the capability of reviewing and modifying stored permissions. For example, suppose the WSP is a wallet. Then, a user may decide to change a particular permission setting and not allow a particular entity access to the user's wallet anymore.

It should further be appreciated that the invention advantageously provides more robust security by having trust kept centrally in the discovery service, rather than having trust spread out in multiple places. When the lifetime of a ticket extends beyond a particular time period, such as a few hours, for example, and especially beyond 24 hours, it becomes necessary to provide a means for invalidating the ticket in some way. On the smaller timeframe of the life of a ticket, the window of opportunity to have to invalidate a ticket is much smaller and the risk therefore is low.

The requirement to invalidate a ticket can require work on the part of the service provider/WSC, the WSP, and the user. Furthermore, invalidating a ticket would also require that the WSP be relied upon to do the right thing, e.g. checking that a ticket is cancelled before it grants access because of it. Such checking puts a heavy trust reliance on the implementation at the WSP. Whereas according to a preferred embodiment of the invention, invalidating a ticket need only involve the discovery service. The preferred embodiment of the invention has and leverages a heavy trust reliance on the central discovery service, a service in which the user already has a higher level of trust.

It should be appreciated that the discovery service provides means for supporting users having different WSP(s) accessed by different WSP applications, even though the users may share the same service provider. For example, one user could have a Citibank wallet, another could have a MasterCard wallet, and another could have an AOL wallet. That is, the preferred embodiment of the invention provides architecture to support every user having a different wallet through use of the discovery service, which keeps track of such user information.

An Exemplary Implementation

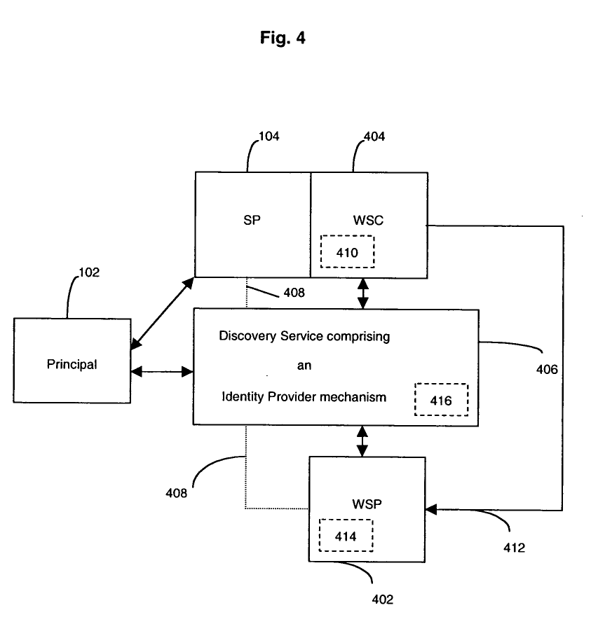

One embodiment can be described with reference to FIG. 4. A Web service provider (WSP) 402 typically is configured in such as way such that a calling Web Service Client (WSC) 404 must prove that the Principal 102 requesting the service has a live authenticated session with the WSC 404. Such policy is enforced by either the WSP 402 or a discovery service (DS) module 406. As an example, consider the WSC 404 as a subscription service and the WSP 402 as a user's wallet application. It is assumed that the service provider 104, the WSC 404, and the WSP 402 all had previously agreed to work with each other 408.

In one embodiment of the invention, during a request for performing a transaction and to prove user presence, the WSC 404 comprises a previously attained assertion signed by the identity provider (IDP) mechanism 406, wherein the assertion contains a statement 410 that the user, Principal 102, is authenticated during the registration period, but does not have a live authenticated session in progress.

This statement 410 logically comprises at least the following four pieces of information:

The system entity making the assertion (typically the IDP);

The system entity making the request (the WSC);

The system entity relying on the assertion (the WSP); and

The name identifier of the Principal in the namespace of the IDP->WSP (the relying party).

The WSC 404 obtains this user presence statement 410 by a variety of means; two examples follow.

First, in one embodiment, the user presence statement 410 is included in an extended assertion, e.g. a ticket, that is given to the service provider 104 at the time of authentication (as described above).

Second, in another example, the WSC 404 can present to the DS 406 a service assertion it obtained from another system entity (likely another WSC) that contains a user presence statement. The DS will then issue a new service assertion containing a new user presence statement. This allows for a WSP to also become a WSC and invoke a user service at another WSP and still prove user presence.

In another embodiment of the invention, the discovery service 406 doesn't send the ticket 410 to the WSC 404. Instead, the discovery service 406 itself records and stores the user statement information 416 for future use by the WSC 404. The stored user statement information 416 could be in the form of a table, for example.

In another embodiment of the invention, the WSP 402 stores the ticket 414. When the WSC 404 makes a request to use the WSP 402, the WSC 404 contacts the DS 406 first which tells the WSC 404 where to go for the service 412, i.e. to the WSP 402. Then, the WSP 402 uses the ticket 414 to check that the WSC 404 does indeed have permission to request the transaction in the absence of the user.

An Alternate Means for Registration

It should be appreciated that in one embodiment of the invention, the WSC 404 comprises means for first testing a request to the WSP 402 while the user is still present. That is, the WSC 404 can make a request for a transaction indicating that the request is just a test, such as, by having a test flag turned on, for example. Then, in this embodiment of the invention, either or both the DS 406 and the WSP 402 can perform real-time consent informational data collection from the user without having actually performed the particular transaction. In this way, the WSC 404 is confident and comfortable that such operation will succeed (although it may fail for other reasons) when the user is not present at a later point in time.

### An Exemplary Chaining of Services

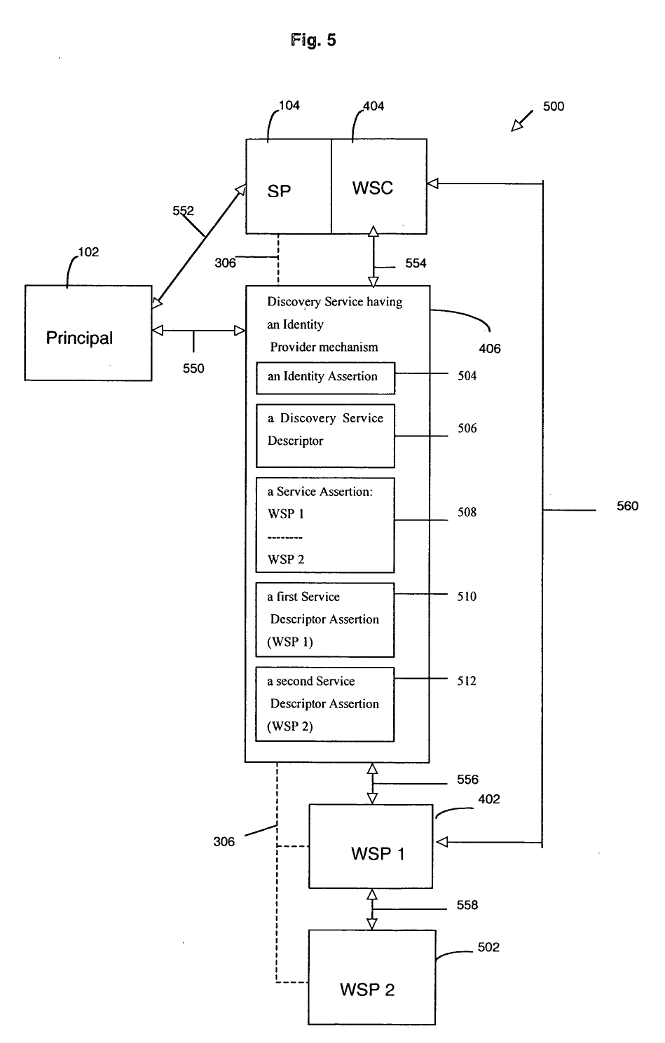

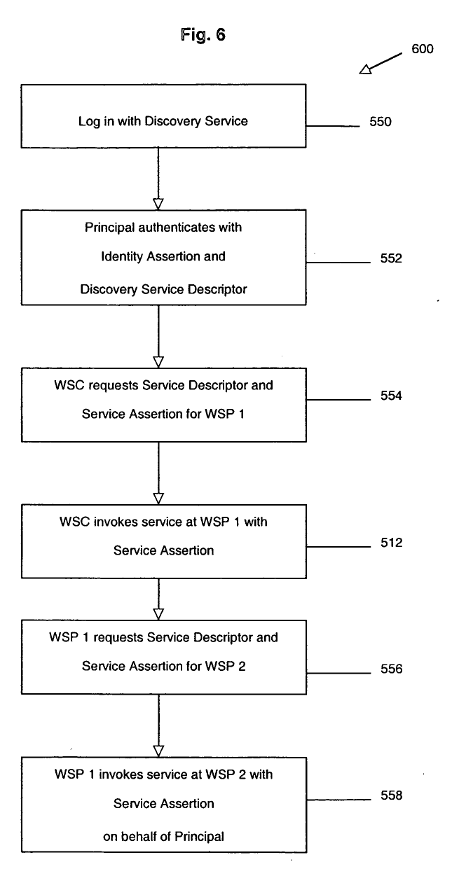

One embodiment of the invention is described with reference to FIGS. 5 and 6. FIG. 5 is a high level functional block diagram of a Web service system 500 according to the invention. FIG. 6 is a flow diagram 600 for invoking a first service hosted on a first server WSP 1, which in turn invokes a second service hosted at a second server WSP 2. The Web service system 500 includes a Service Provider entity 104 coupled with a Web Service Client interface entity (WSC) 404, a Discovery Service 406 having an Identity Provider mechanism (Discovery Service), a first Web service provider entity 402 (WSP 1), a Principal entity 102, and at least a second Web service provider entity 502 (WSP 2). Such entities are part of a federation relationship 306 in which each entity agrees to a limited form of trust. Each entity of the federation relationship 306 agrees to trust that the information provided by the Discovery Service 406 is true. The Discovery Service 406 authenticates and vouches for the Principal 102 to one or more entities of the federation relationship 306 as well as provides system management for system identities. In one embodiment of the invention, the Discovery Service 406 passes an Identity Assertion 504 associated with the Principal 102 to any Web service participant in the federation relationship 306 to authenticate and vouch for the Principal 102. Each Web service of the federation relationship 306 trusts that the information in the Identity Assertion 504 is true. An example of such Identity Assertion can be found in U.S. patent application Ser. No. 10/678,910, filed Oct. 2, 2003 (Attorney Docket No. AOL0091) which is herein incorporated in its entirety by reference.

In one embodiment of the invention, the Principal 102 logs in the Web service system 500 by way of the Discovery Service 406 (550). In response to the login, the Discovery Service 406 returns (550) an Identity Assertion 504 to the Principal 102 and a Discovery Service Descriptor 506. In response to receiving the Identity Assertion 504 and the Discovery Service Descriptor 506 (550), the Principal 102 authenticates using the Identity Assertion 502 and the Discovery Service Descriptor 506 (552) at a Service Provider 104 coupled to the Web Services Client interface module (WSC) 404 which links to and effectively represents a desired commerce site, such as amazon.com or eBay.

If the WSC 404 needs the services of another Web service, such as a user's wallet service for payment information, the WSC 404 performs the following actions. The WSC 404 makes a request (554) to the Discovery Service 406 for a Service Assertion 508 associated with the user's wallet service and a first Service Descriptor 510 associated with the user's wallet service. The first Service Descriptor 510 contains informational data about the user's wallet service, Web Service Provider 1 (WSP 1) 402. In response to receiving the Service Assertion 508 and the first Service Descriptor 510 from the Discovery Service 406 (554), the WSC 404 invokes the wallet service at WSP 1 402 with the first Service Descriptor 510 and by passing the Service Assertion 508 to WSP 1 402 (512).

It should be appreciated that the Service Assertion 508 can be used interchangeably with, but not limited to tickets, tokens, being notarized by the Identity Provider mechanism of the Discovery Service 406, and being certified by the Identity Provider mechanism of the Discovery Service 406. It should further be appreciated that different forms of implementation comprise, but are not limited to using a string, certificate, public key, other forms of cryptography, and Discovery Keys wherein the Discovery Service has copies of the keys.

It should further be appreciated that in certain embodiments of the invention, the first Service Descriptor 510 contains a URL; a String; or a Simple Object Access Protocol (SOAP) address for Web services.

Suppose that the WSP 1 402 determines it needs another service of another Web service. For example, suppose the wallet service of WSP 1 402 determines it needs the user's address for shipping information from a service such as an Address Book which is stored at WSP 2 502. In one embodiment of the invention, in response to such determination, WSP 1 402 makes a request (556) at the Discovery Service 406 for a second Service Descriptor 512 associated with WSP 2 502 and a Service Assertion associated with WSP 2 502 for the specific service requested, for example the Address Book.

In one embodiment of the invention, the Service Assertion 508 is chained. That is, the Service Assertion for the Address Book service is concatenated to the service assertion for the wallet service. Specifically, the Discovery Service 406 adds the second service assertion associated with service of WSP 2, e.g. Address Book, to the Service Assertion 508 thereby adding and retaining a footprint of the requested service for WSP 1 and the requested service for WSP 2 on behalf of the user. That is, the invention allows the Service Assertion to keep a footprint of each and every requested service for a particular transaction on behalf of a user.

In response to the request at the Discovery Service 406 for the second Service Descriptor 512 and the Service Assertion 508 for WSP 2 502, WSP 1 402 invokes the service (558) on behalf of the Principal 102 by passing the Service Assertion 508 to WSP 2 502.

It should be appreciated that the Service Assertion 508 is chained and is only applicable during a particular transaction. For example, the Service Assertion 508 for the Address Book service is only good for use with the particular wallet service from, for example, Wells Fargo Bank, and with the request coming from the WSC 404, for example, from amazon.com.

It should further be appreciated that the invention allows a WSP from a federation relationship to invoke other services from other members of the federation relationship required to perform its service. As each WSP calls or requests a service from another WSP, the Discovery Service adds the called WSP's footprint to the Service Assertion it passes on, such that a trail of WSP's is imprinted in the Service Assertion and is visible to the Discovery Service. Each WSP in the chain can also add permission requests.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A method for a first Web service provider to invoke a service hosted on a second Web service provider on behalf of a principal in a computer environment, comprising the steps of:
said principal logging in with a discovery service;
said discovery service passing to said principal an identity assertion associated with said principal and a discovery service descriptor associated with said discovery service for use by principal for future authentication;
said principal authenticating using said identity assertion and using said discovery service descriptor at a Web service client, said Web service client linking to and representing a desired commerce site of said principal;
in response to an action related to said desired commercial site, said Web service client requesting a first service descriptor associated with said first Web service and a first service assertion associated with said first Web service from said discovery service;
in response to receiving said first service descriptor and said first service assertion, said Web service client invoking a desired service at said first Web service;
upon said first Web service determining a need to invoke a second desired service at a second Web service, said first Web service requesting from said discovery service a second service descriptor associated with said second Web service and a second service assertion associated with said second Web service; and
in response to receiving said request for said second service descriptor and said second service assertion, said discovery service adding said second service assertion to said first service assertion and subsequently passing said first service assertion and said second service descriptor to said first Web service;
in response to receiving said first service assertion and second service descriptor, said first Web service invoking said desired second service at said second Web service.

2. The method of claim 1, wherein said first Web service invokes one or more services hosted on one or more Web servers.

3. The method of claim 1, wherein said Web service client, said discovery service, said first Web server, and said second Web server are members of a federation relationship in which each member trusts said discovery service.

4. The method of claim 1, wherein said service assertion is any of, but not limited to:
a ticket;
a token;
is notarized by said discovery service; and
is certified by said discovery service.

5. The method of claim 4, wherein said service assertion is implemented using any of, but not limited to:
a string;
a certificate;
a public key;
discovery keys wherein the discovery service has copies of the keys; and
any other form of cryptography.

6. The method of claim 1, wherein said service descriptor comprises any of, but not limited to:
a URL;
a String; and
a Simple Object Access Protocol (SOAP) address for Web services.

7. An apparatus for a first Web service provider to invoke a service hosted on a second Web service provider on behalf of a principal in a computer environment, comprising:
means for said principal logging in with a discovery service;
means for said discovery service passing to said principal an identity assertion associated with said principal and a discovery service descriptor associated with said discovery service for use by principal for future authentication;
means for said principal authenticating using said identity assertion and using said discovery service descriptor at a Web service client, said Web service client linking to and representing a desired commerce site of said principal;
in response to an action related to said desired commercial site, means for said Web service client requesting a first service descriptor associated with said first Web service and a first service assertion associated with said first Web service from said discovery service;
in response to receiving said first service descriptor and said first service assertion, means for said Web service client invoking a desired service at said first Web service;
upon said first Web service determining a need to invoke a second desired service at a second Web service, means for said first Web service requesting from said discovery service a second service descriptor associated with said second Web service and a second service assertion associated with said second Web service; and
in response to receiving said request for said second service descriptor and said second service assertion, means for said discovery service adding said second service assertion to said first service assertion and subsequently passing said first service assertion and said second service descriptor to said first Web service;
in response to receiving said first service assertion and second service descriptor, means for said first Web service invoking said desired second service at said second Web service.

8. The apparatus of claim 7, wherein said first Web service invokes one or more services hosted on one or more Web servers.

9. The apparatus of claim 7, wherein said Web service client, said discovery service, said first Web server, and said second Web server are members of a federation relationship in which each member trusts said discovery service.

10. The apparatus of claim 7, wherein said service assertion is any of, but not limited to:
a ticket;
a token;
is notarized by said discovery service; and
is certified by said discovery service.

11. The apparatus of claim 10, wherein said service assertion is implemented using any of, but not limited to:
a string;
a certificate;
a public key;
discovery keys wherein the discovery service has copies of the keys; and
any other form of cryptography.

12. The apparatus of claim 7, wherein said service descriptor comprises any of, but not limited to:
a URL;
a String; and
a Simple Object Access Protocol (SOAP) address for Web services.

13. A program storage medium readable by a computer, tangibly embodying a program of instructions executable by the computer to perform a method for updating address information in a computer environment, the method comprising the steps of:
said principal logging in with a discovery service;
said discovery service passing to said principal an identity assertion associated with said principal and a discovery service descriptor associated with said discovery service for use by principal for future authentication;
said principal authenticating using said identity assertion and using said discovery service descriptor at a Web service client, said Web service client linking to and representing a desired commerce site of said principal;
in response to an action related to said desired commercial site, said Web service client requesting a first service descriptor associated with said first Web service and a first service assertion associated with said first Web service from said discovery service;
in response to receiving said first service descriptor and said first service assertion, said Web service client invoking a desired service at said first Web service;
upon said first Web service determining a need to invoke a second desired service at a second Web service, said first Web service requesting from said discovery service a second service descriptor associated with said second Web service and a second service assertion associated with said second Web service; and
in response to receiving said request for said second service descriptor and said second service assertion, said discovery service adding said second service assertion to said first service assertion and subsequently passing said first service assertion and said second service descriptor to said first Web service;
in response to receiving said first service assertion and second service descriptor, said first Web service invoking said desired second service at said second Web service.

14. The medium of claim 13, wherein said first Web service invokes one or more services hosted on one or more Web servers.

15. The medium of claim 13, wherein said Web service client, said discovery service, said first Web server, and said second Web server are members of a federation relationship in which each member trusts said discovery service.

16. The medium of claim 13, wherein said service assertion is any of, but not limited to:
a ticket;
a token;
is notarized by said discovery service; and
is certified by said discovery service.

17. The medium of claim 16, wherein said service assertion is implemented using any of, but not limited to:
a string;
a certificate;
a public key;
discovery keys wherein the discovery service has copies of the keys; and
any other form of cryptography.

18. The medium of claim 13, wherein said service descriptor comprises any of, but not limited to:
a URL;
a String; and
a Simple Object Access Protocol (SOAP) address for Web services.

19. A process for a first Web service provider to invoke a service hosted on a second Web service provider on behalf of a principal in a computer environment, comprising the steps of:
said principal logs in with a discovery service for subsequent authentication;
in response to said log in, said discovery service passing an identity assertion and a discovery service descriptor to said principal;
said principal uses said identity assertion and said discovery service descriptor to access a Web commerce site with a Web service client software interface application;
said Web service client software interface application requesting a first service descriptor and a first service assertion for a first desired service at a first Web server from said discovery service;
in response to receiving said first service descriptor and said first service assertion from said discovery service said Web service client software interface application invoking said first desired service at said first Web server;
said first Web server requesting a second service descriptor and a second service assertion for a second desired service at a second Web server from said discovery service; and
in response to receiving said second service descriptor and said second service assertion from said discovery service, said first Web server invoking said second desired service at said second Web server on behalf of said principal.

20. An apparatus for a first Web service provider to invoke a service hosted on a second Web service provider on behalf of a principal in a computer environment, comprising:
means for said principal logs in with a discovery service for subsequent authentication;
in response to said log in, means for said discovery service passing an identity assertion and a discovery service descriptor to said principal;
means for said principal using said identity assertion and said discovery service descriptor to access a Web commerce site with a Web service client software interface application;
means for said Web service client software interface application requesting a first service descriptor and a first service assertion for a first desired service at a first Web server from said discovery service;
in response to receiving said first service descriptor and said first service assertion from said discovery service, means for said Web service client software interface application invoking said first desired service at said first Web server;
means for said first Web server requesting a second service descriptor and a second service assertion for a second desired service at a second Web server from said discovery service; and
in response to receiving said second service descriptor and said second service assertion from said discovery service, means for said first Web server invoking said second desired service at said second Web server on behalf of said principal.

21. A program storage medium readable by a computer, tangibly embodying a program of instructions executable by the computer to perform a method for updating address information in a computer environment, the method comprising the steps of:
said principal logs in with a discovery service for subsequent authentication;
in response to said log in, said discovery service passing an identity assertion and a discovery service descriptor to said principal;
said principal uses said identity assertion and said discovery service descriptor to access a Web commerce site with a Web service client software interface application;
said Web service client software interface application requesting a first service descriptor and a first service assertion for a first desired service at a first Web server from said discovery service;
in response to receiving said first service descriptor and said first service assertion from said discovery service, said Web service client software interface application invoking said first desired service at said first Web server;
said first Web server requesting a second service descriptor and a second service assertion for a second desired service at a second Web server from said discovery service; and
in response to receiving said second service descriptor and said second service assertion from said discovery service, said first Web server invoking said second desired service at said second Web server on behalf of said principal.
